(19) United States
(12) Patent Application Publication
(10) Pub. No.: US 2011/0261441 A1
(43) Pub. Date: Oct. 27, 2011

(54) Spectral Filter

(75) Inventors: Nikolay I. Zheludev, Southampton (GB); Eric Plum, Southampton (GB); Vassili A. Fedotov, Southampton (GB)

(73) Assignee: University of Southampton

(21) Appl. No.: 13/093,463

(22) Filed: Apr. 25, 2011

(30) Foreign Application Priority Data
Apr. 26, 2010 (GB) GB 1006944.1

(51) Int. Cl. G02B 27/28; H01J 29/46; G02B 5/20

(52) U.S. Cl. 359/352; 359/489.01; 250/505.1; 359/487.01

(57) ABSTRACT

This invention relates to use of metamaterials for creating spectral selectors of electromagnetic radiation. Planar metamaterial films patterned on the sub-wavelength scale can be used in polarization filters instead of natural and synthesized bulk crystals. Characteristics and the quality factor of metamaterial filters is controlled by the geometry of the pattern. Various types of metamaterials and filter configurations are proposed.

### CROSS-REFERENCE TO RELATED APPLICATION

This patent application claims priority to GB Application No. 1006944.1 filed Apr. 26, 2010.

### FIELD OF THE INVENTION

This invention relates to use of metamaterials for creating spectral selectors of electromagnetic radiation.

### INTRODUCTION

The recent proof of principle demonstration of negative index media, super-resolution devices and optical cloaks achieved with metamaterials create enormous excitement in the photonic community, see, for example, D. R. Smith et al., Science 305, 788 (2004).

Metamaterials derive their electromagnetic properties from artificial structuring on the sub-wavelength scale. Moreover, the ability to tailor the symmetry of metamaterials and the resonant properties of their optical response allows for unusual functionalities such as asymmetric transmission of light and mimicking electromagnetically induced transparency, see, for example, V. A. Fedotov et al., Phys. Rev. Lett. 97, 167401 (2006). However, these exciting demonstrations are yet far from being practically deployable and years may be required to engineer competitive metamaterial-based devices. Here we identify a new field where photonic metamaterials manufactured by current technology may be used in practical applications. Spectral filters are a basic component of optical instrumentation used in various applications from telecommunications and vision to sensors and spectroscopy. Birefringent polarization filters are sophisticated devices that occupy a very special role in the family of spectral filters: due to their ability to provide narrow band selectivity combined with a wide angle of view they are ideally suited for communication applications in scattering media, like information exchange with a submarine immersed in deep waters which perhaps explains a strong interest in these filters about thirty years ago, during the Cold War. We show that planar metamaterial films patterned on the sub-wavelength scale can be used as core, frequency selective element in polarization filters instead of traditionally employed natural and synthesized crystals offering a unique opportunity of engineering the transmission wavelength that can be placed anywhere within an extremely wide spectral range, from microwaves to the visible part of the spectrum.

One of the most elegant and best performing polarization spectral filters was suggested by Henry, (C. H. Henry, Phys. Rev. 143, 627 (1966)). Its functionality depends on the energy exchange between two orthogonally polarized modes in a birefringent crystal in the proximity of the spectral point λ_{0B} when birefringence changes its sign. At wavelengths away from this point when birefringence is substantial, two orthogonally polarized waves (the “ordinary” and “extraordinary” waves) are good eigenstates of the system and coupling (energy transfer) between them does not take place. If the crystal is placed between two crossed linear polarizers aligned along the eigenpolarizations no light will be transmitted through the device. However, near the birefringence zero crossing point where the crystal shows nearly isotropic behavior, a small perturbation can lead to efficient coupling of the waves and energy exchange between them. Stress, magnetic field and optical activity could act as the perturbation. For instance if natural optical activity of the crystal rotates the polarization state of light by 90° at the zero-crossing frequency, a high, background-free transmission of the device comprising of two crossed polarizers and the crystal will be observed at the zero-crossing frequency (see FIG. 1a). The filter with a crystal of length L will have a narrow transmission peak with a width that depends on the dispersion of its birefringence ∂n/∂λ near the zero -crossing point: Δλ=(λ_{0B}/2L)/(∂n/∂λ). The filter transmission characteristics at the zero-crossing point are a function of polarization rotary power of the crystal: if losses could be neglected it would grow monotonously from zero and reach unity for GL=90° where G is specific rotary power of the medium at λ_{0B}. In the ideal case for such a filter birefringence is a steep function of the wavelength near λ_{0B} while optical activity is wavelength independent. A complementary form of the filter suggested by Zheludev (see N. I. Zheludev, Sov. J. Quantum Electron. 19, 993 (1989)) is also known (see FIG. 1b). This filter requires an optically active medium with the rotary power changing sign at some wavelength λ_{0G} (isogyration point). Here circularly polarized eigenstates become easily disturbed by small linear birefringence and a spectral filter can be assembled by placing the medium between two circular polarizers. Under optimal conditions the spectral width of the filter is controlled by the dispersion of optical activity ∂G/∂λ a near the isogyration point Δλ=(π/λ)/(∂G/∂λ). The isoindex filter has been extensively studied and initially demonstrated with CdS crystals and CuAlSe₂ crystals that have natural isoindex points at the wavelengths of 523 nm and 531 nm respectively.

### BRIEF DESCRIPTION OF THE DRAWINGS

FIG. 1 A filter with (a) an isoindex gyrotropic crystal, (b) an isogyration birefringent crystal.

FIG. 2 Images of example metamaterials with arrays of asymmetrically split ring apertures for (a) a microwave filter and (b) an optical filter.

FIG. 3 Transmission spectra for the material shown in FIG. 2(a)

FIG. 4 Transmission spectra for the material shown in FIG. 2 (b)

FIG. 5 Filter: Example 1

FIG. 6 Filter: Example 2

FIG. 7 Filter: Example 3

FIG. 8 Filter: Example 4

FIG. 9 Filter: Example 5

FIG. 10 Filter: Example 6

FIG. 11 Filter: Example 7

FIG. 12 Filter: Example 8

FIG. 13 Filter: Example 9

FIG. 14 Filter: Example 10

FIG. 15 Filter: Example 11

FIG. 16 Filter: Example 12.1

FIG. 17 Filter: Example 12.2

FIG. 18 Filter: Example 12.3

FIG. 19 Filter: Example 12.4

FIG. 20 Filter: Example 13.1

FIG. 21 Filter: Exainple 13.2

FIG. 22 Metamaterial for use in filter: Example 1

FIG. 23 Metamaterial for use in filter: Example 2

FIG. 24 Metamaterial for use in filter: Example 3

FIG. 25 Metamaterial for use in filter: Example 4

FIG. 26 Metamaterial for use in filter: Example 5

FIG. 27 Metamaterial for use in filter: Example 6

FIG. 28 Metamaterial for use in filter: Example 7

FIG. 29 Metamaterial for use in filter: Example 8

FIG. 30 Metamaterial for use in filter: Example 9

FIG. 31 Metamaterial for use in filter: Example 10

FIG. 32 Metamaterial for use in filter: Example 11

FIG. 33 Metamaterial for use in filter: Example 12

FIG. 34 Metamaterial for use in filter: Example 13

FIG. 35 Metamaterial for use in filter: Example 14

FIG. 36 Metamaterial for use in filter: Example 15

FIG. 37 Metamaterial for use in filter: Example 16

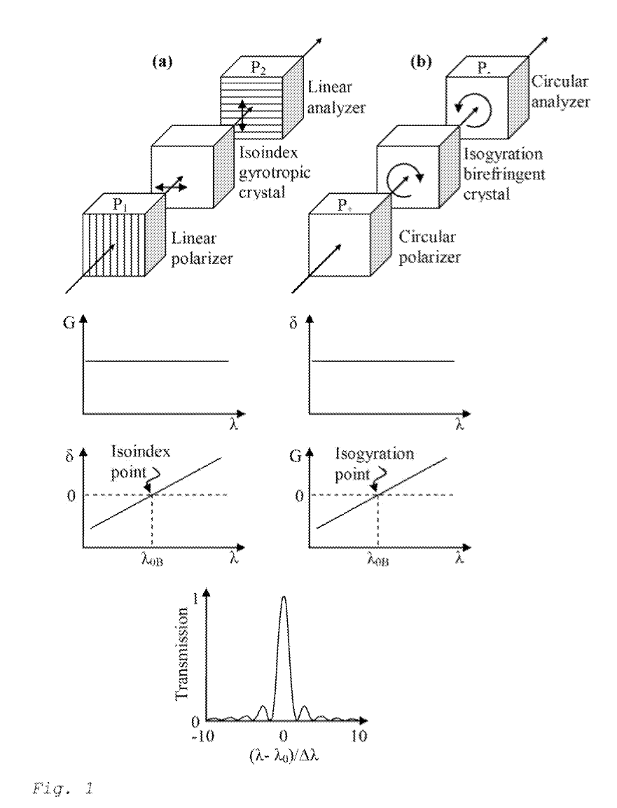

### DETAILED DESCRIPTION OF THE PREFERRED EMBODIMENT

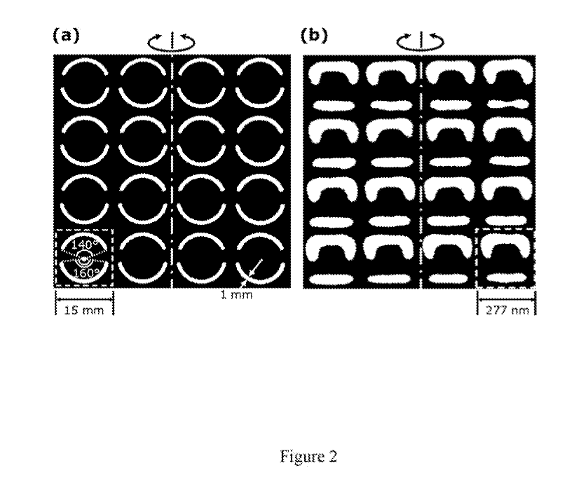

Here we show that planar metamaterial films patterned on the sub-wavelength scale can be used in polarization filters instead of natural and synthesized bulk crystals. A suitable metamaterial for this application is a recently introduced meta-surface that shows closed mode Fano-type resonances engaged through a weak coupling between a low quality dipole mode and a high-quality non-radiating magneto-dipole mode of excitation: an array of asymmetrically split rings (see FIG. 2). This metamaterial is anisotropic by design, however, linear birefringence and dichroism associated with this anisotropy vanish at a particular spectral point that is equivalent to the isoindex point in bulk birefringent crystals. Moreover the pattern shows resonant optical activity that is needed for mode coupling. Polarization rotation in this metamaterial structure appears as a result of “extrinsic chirality” derived from the mutual orientation of the beam and the structure and only appears at non-normal incidence onto the metamaterial. Here the magnitude of polarization rotatory power is a function of the incidence angle which can be exploited for tuning the filter's transmission.

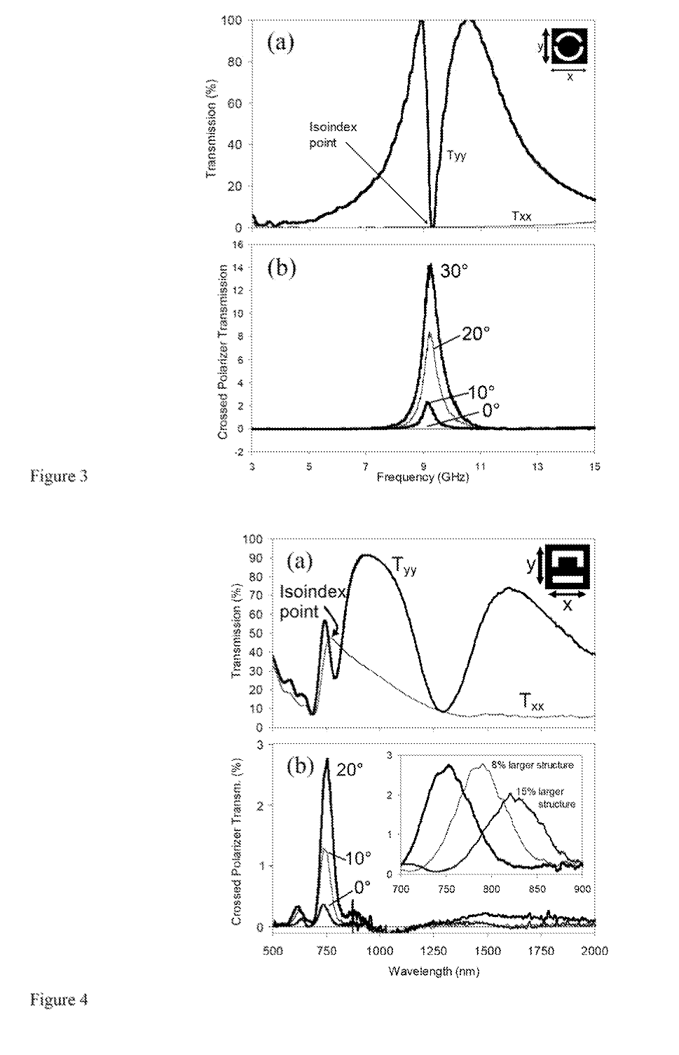

The metamaterial filters demonstrated here are based on metal films perforated with a regular array of asymmetrically split ring apertures, see FIG. 2. In contrast to crystal-based filters, the microwave and photonic metamaterial structures are thin compared to the filter's operating wavelength and can be seen as essentially planar interfaces. Each split ring simply consists of two slits of different lengths and is not chiral. Thus, at normal incidence the pattern has two linearly polarized eigenstates oriented parallel and perpendicular to the slits. The transmission spectra for these eigenstates are shown in FIGS. 3a and 4a respectively. Importantly, the polarization perpendicular to the slits, y, excites a narrow resonance which gives rise to an isoindex point making it a candidate for the realization of a Henry filter, if coupling between the eigenstates can be introduced. The resonance itself has been identified as a magnetic dipole mode, which cannot contribute to the scattered field under normal incidence conditions.

Coupling between the eigenstates becomes possible at oblique incidence thanks to two factors. Firstly, the magnetic mode, which corresponds to magnetic moments oscillating normal to the metamaterial plane, acquires a component normal to the propagation direction and can therefore contribute to scattering. Secondly, when the metamaterial is tilted by an angle a around its symmetry axis, the experimental arrangement becomes different from its mirror image (tilt −a) and therefore extrinsically chiral. Chirality, combined with the magnetic resonance lead to a narrow band of strong optical activity and thus strong coupling between the eigenstates, which can be exploited by a Henry filter. FIGS. 3b and 4b show the transmission of Henry filters based on the microwave and photonic metamaterials as a function of the metamaterial tilt. In the normal incidence (“off”) configuration, transmission of the microwave filter is essentially zero over the entire studied spectral range from 3-15 GHz. When the metamaterial is tilted, a narrow transmission band at 9.3 GHz opens up, where transmission rapidly increases with the tilt angle a, reaching 14% for a=30°. Also the quality factor of the transmission window is controlled by the tilt angle, it reduces from 21 for a=10° to 15 for a=30°. Similar behavior is seen for the Henry filter in the optical part of the spectrum. At normal incidence transmission is remains well below 0.5% over the full studied spectral range from 500 nm to 2000 nm, while for a=10° a narrow transmission band appears at 740 nm. When the metamaterial is tilted further to a=20° transmission doubles to 2.7% and the transmission band shifts slightly to 750 nm with a quality factor of about 13 in both cases.

As illustrated by the inset to FIG. 4b filters for any wavelength can be realized through scaling the size of the metamaterial structure, where the transmission wavelength essentially corresponds to twice the average slit length (red-shifted by the dielectric substrate). Also the quality factor of metamaterial filters of this type is controlled by the geometry of the split ring aperture, it depends on the asymmetry of the split ring. For low loss materials, much higher quality factors than demonstrated here should be expected for split rings of low asymmetry.

In conclusion we have demonstrated that planar metamaterials may be used in background-free narrow-band transmission line free-space polarization filters operating at the isoindex wavelength. Being essentially a metal film with narrow slits of precisely engineered shape such filters can be manufactured to operate at any wavelength, from microwaves to the visible. Tailoring the shape of the slits and tilt of the metamaterial plane with respect to the filter axis allows the transmission line's width to be controlled and Q-factors exceeding several hundreds to be achieved. Moreover, the only other essential components of the filter, the polarizers, can also be manufactured as metamaterial structures (wire grid) thus allowing for a full metamaterial based device.

### Methods

### Metamaterial Structures and Fabrication

The microwave metamaterial consists of a periodic array of about 200 asymmetric split ring apertures milled into a self-standing 1 mm thick aluminum sheet, see FIG. 2a. The split ring pattern is repeated every 15 mm and consists of 140° and 160° arcs of 1 mm width and radius 6 mm. The photonic metamaterial shown in FIG. 2b is an array of asymmetrically split nano-rings cut into a 70 nm thick gold film by focused ion beam milling. The gold film is supported by a 100 nm thick silicon nitride membrane. Three 20×20 μm² sized samples of photonic metamaterial were manufactured with respective periods of 277, 298 and 319 nm.

### Transmission Experiments

The transmission properties of the microwave metamaterial were investigated between 3 and 15 GHz in a microwave anechoic chamber using two linearly polarized horn antennas (Schwarzbeck BBHA 9120D) equipped with lens concentrators and a vector network analyzer (Agilent E8364B). Transmission through the photonic structure was studied from 500 to 2000 nm using a microspectrophotometer equipped with linear polarizers. Both structures are non-diffracting for the spectral ranges studied in the experiments.

### Definitions

Metamaterial is artificial medium regularly structured on a scale smaller that the wavelength of electromagnetic radiation.

Linear Birefringence is the ability of a medium to support two linearly polarized waves propagating with different velocities.

Linear dichroism is the ability of a medium to support two linearly polarized waves propagating with different losses.

Circular birefringence is the ability of a medium to support two circularly polarized waves propagating with different velocities

Circular dichroism is the ability of a medium to support two circularly polarized waves propagating with different losses.

Linear polarizer is a device that predominantly transmits electromagnetic waves with a given linear polarization.

Linear analyser is a device that predominantly transmits electromagnetic waves with a given linear polarization.

Circular polarizer is a device that predominantly transmits electromagnetic waves with a given circular polarization.

Circular analyser is a device that predominantly transmits electromagnetic waves with a given circular polarization.

### Benefits

The invention brings the following benefits:

Broader spectrum of operation. Prior art polarization spectral filters are based on natural or artificially grown crystals that only posses the required characteristics in the optical part of the spectrum. The proposed invention allows for manufacturing of filters working at any frequency in the entire electromagnetic spectrum. Most importantly this covers the far-IR and THz ranges where it is extremely difficult to achieve good spectral filters and which are technologically important and relevant to defence.

Any prescribed wavelength. Prior art polarization spectral filters can only operate at a particular wavelength that is natural to a particular crystal type. For instance iso-birefringent filters based on CuAlSe2 work at a wavelength of 531 nm. It is not possible to change this wavelength. The proposed invention allows for manufacturing filters operating at any prescribed wavelength from microwaves to optics by engineering the metamaterial structure.

Cheaper to manufacture. Prior art polarization spectral filters use expensive crystalline materials (a few thousands £ per crystal). Metamaterials are much cheaper to produce, in particular for infrared, THz and microwave applications (could be less than £1 per active element). Widely spread production technologies such as PC board technology and silicon chip technologies may be used to produce metamaterials.

Tuneability. Prior art polarization spectral filters are not tuneable which limits their applications. The proposed invention allows for tuning of some characteristics of the filter, such as peak transmission and line width.

Size matters. Prior art polarization spectral filters are bulk with sizes on the scale of centimetres. Filters with large area that are needed for communication applications are impossible or extremely expensive to manufacture. The proposed invention allows for cheap manufacturing of very thin filters with unlimited area. Such film-type filters can be used in various telecom applications and in highly integrated photonic, THz and microwave devices.

### Potential Applications

Spectral filters are key elements of electromagnetic technology and are used in a huge range of microwave, terahertz, infrared and visible spectral range devices. Examples are:
1. Communication systems, filtering the desirable signal from background noise and scattered radiation from other sources (i.e. optical communication of a deeply submersed submarine with an airplane in day light).
2. Data processing systems, filtering or re-routing a desirable signal from other signals in the same channel (i.e. WDM technology, colour photography)
3. Device protection, filtering a desirable signal or shielding personnel from damaging signals and destructive jamming noise (protective goggles for fighter pilots, input filters in communication receivers)
4. Energy conversion devices (heat-blocking windows)
5. Sensors (THz detection of explosive substances with a certain spectral signature at airports, pollution detectors)
6. Various test and measurement equipment and instruments

New spectral filters will generate interest in a large number of industries.

### EXAMPLES

The following figures show the filter configuration examples.

### Example 1

### FIG. 5 Filter:

1. Polarizer
2. Metamaterial
3. Polarizer
4. Incident beam/coherent or incoherent electromagnetic signal
5. Filtered beam/electromagnetic signal

### Example 2

### FIG. 6 Filter:

1. Polarizer
2. Metamaterial
3. Polarizer
4. Incident beam/coherent or incoherent electromagnetic signal
5. Filtered beam/electromagnetic signal
6. Metamaterial can be rotated around this axis

### Example 3

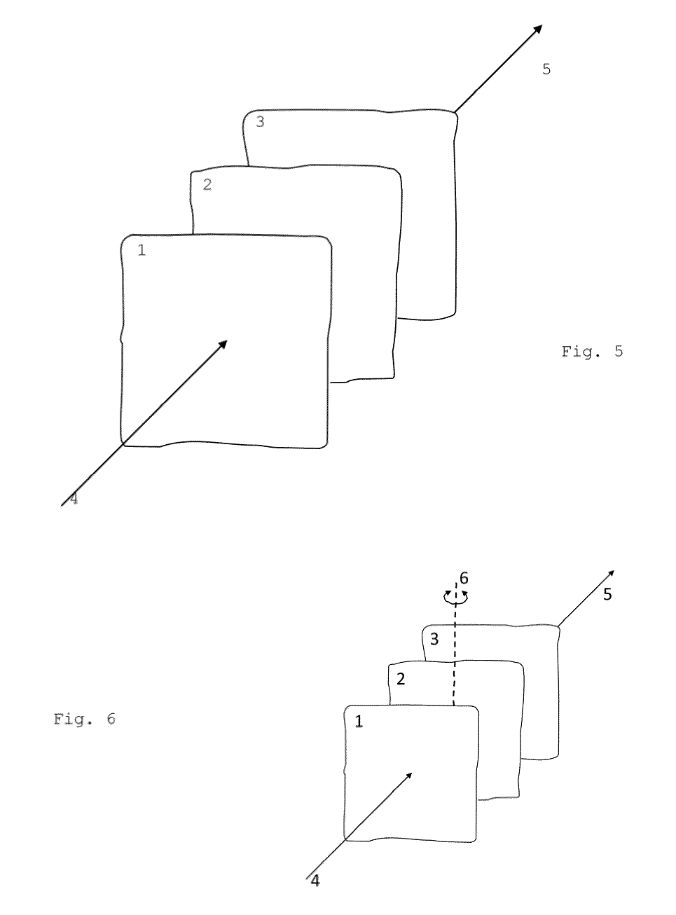

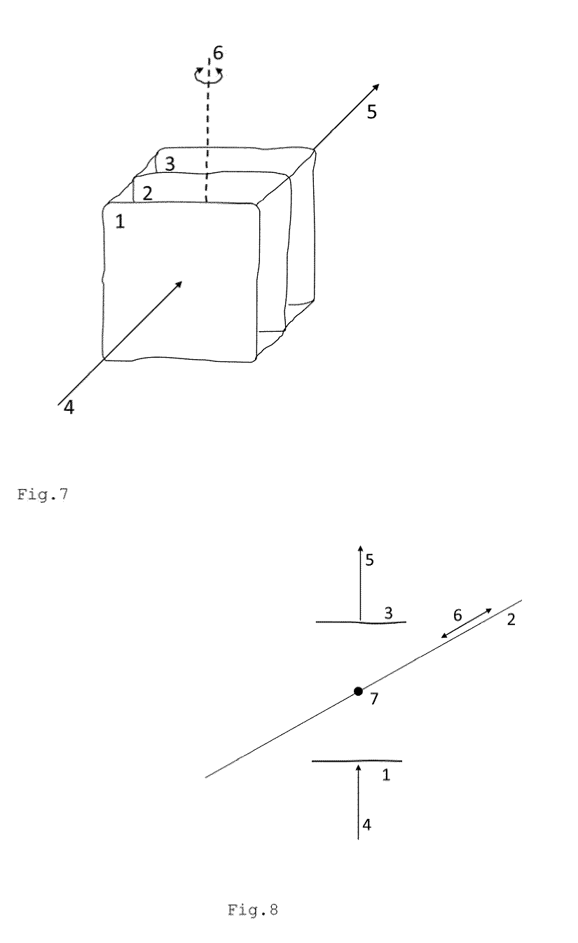

### FIG. 7 Filter:

1. Polarizer
2. Metamaterial
3. Polarizer
4. Incident beam/coherent or incoherent electromagnetic signal
5. Filtered beam/electromagnetic signal
6. Polarizer-metamaterial-polarizer structure can be rotated around this axis

### Example 4

### FIG. 8 Filter:

1. Polarizer
2. Metamaterial with continuously or discretely changing properties
3. Polarizer
4. Incident beam/coherent or incoherent electromagnetic signal
5. Filtered beam/electromagnetic signal
6. Metamaterial can be moved in these directions
7. Optional axis of rotation

### Example 5

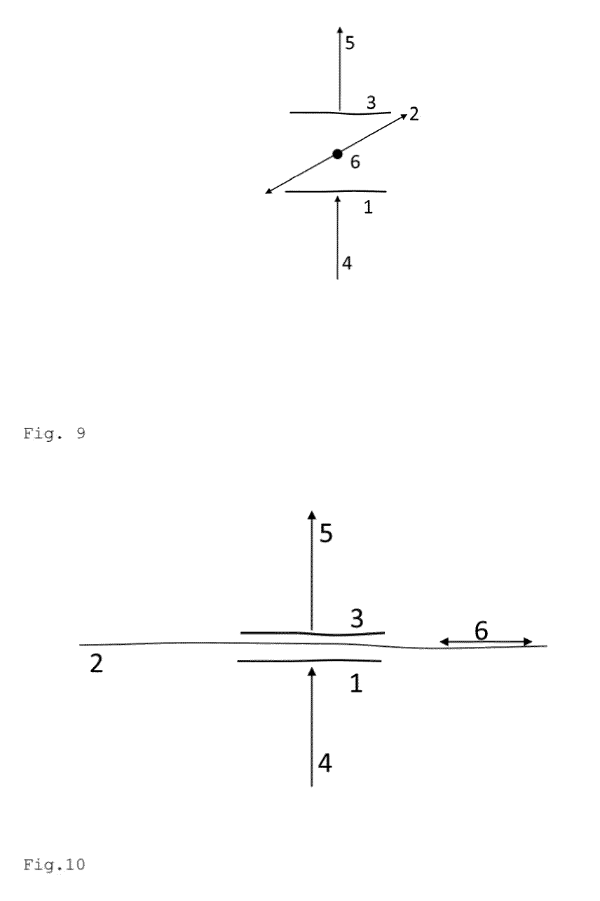

### FIG. 9 Filter:

1. Polarizer
2. Elastic metamaterial which can be stretched in one or two dimensions
3. Polarizer
4. Incident beam/coherent or incoherent electromagnetic signal
5. Filtered beam/electromagnetic signal
6. Optional axis of rotation

### Example 6

### FIG. 10 Filter:

1. Polarizer
2. Metamaterial with continuously or discretely changing properties
3. Polarizer
4. Incident beam/coherent or incoherent electromagnetic signal
5. Filtered beam/electromagnetic signal
6. Metamaterial can be moved in these directions

### Example 7

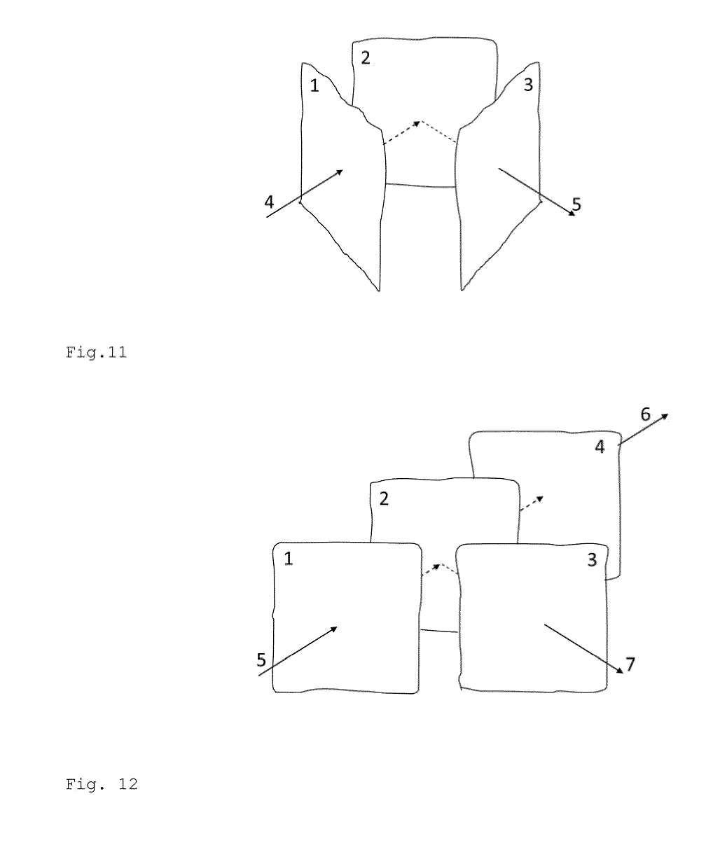

### FIG. 11 Filter:

1. Polarizer
2. Metamaterial
3. Polarizer
4. Incident beam/coherent or incoherent electromagnetic signal
5. Filtered beam/electromagnetic signal

### Meta Materials

This filter uses reflection off the metamaterial.

### Example 8

### FIG. 12 Filter:

1. Polarizer
2. Metamaterial
3. Polarizer
4. Polarizer
5. Incident beam/coherent or incoherent electromagnetic signal
6. Transmitted filtered beam/electromagnetic signal
7. Reflected filtered beam/electromagnetic signal
This filter splits the incident signal into two filtered beams (6) and (7). FIG. 13 Filter:

### Example 9

### FIG. 13

Any of these filters could be integrated into a wave guide, for example:
   1. Linearly polarized waveguide
   2. Metamaterial at waveguide transition
   3. Linearly polarized waveguide
   4. Incident beam/coherent or incoherent electromagnetic signal
   5. Filtered beam/electromagnetic signal

### Example 10

### FIG. 14 Filter:

1. Waveguide
2. Polarizer-metamaterial-polarizer structure
3. Waveguide
4. Incident beam/coherent or incoherent electromagnetic signal
5. Filtered beam/electromagnetic signal
6. Optional axis of rotation for polarizer-metamaterial-polarizer structure

### Example 11

### FIG. 15 Filter:

1. Incident beam/coherent or incoherent electromagnetic signal.
2. & 4. Polarizing optical fibre or combination of optical fibre and polarizer (free-standing or fiberized).
3. Metamaterial. It can be either free-standing or integrated into the fibre system (for example, by fabricating it on the tip of one the fibres).
5. Filtered beam/electromagnetic signal

### Example 12.1

### FIG. 16 Filter:

1. Incident beam/coherent or incoherent electromagnetic signal.
2. & 4. Prisms made out of birefringent materials (such as, for example, calcite) having the same/similar refractive properties with respect to ordinary and extraordinary linear polarizations P1 and P2 (birefringence of the same sign).
3. Metamaterial.
5. Transmitted filtered beam/electromagnetic signal with P1 (corresponds to notch filter).

### Example 12.2

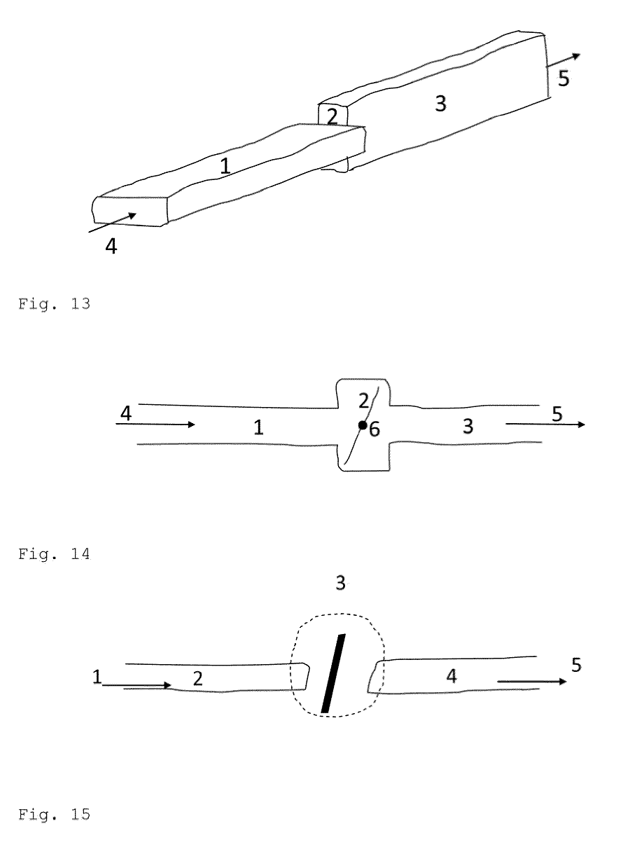

### FIG. 17 Filter:

1. Incident beam/coherent or incoherent electromagnetic signal.
2. & 4. Prisms made out of birefringent materials (such as, for example, calcite) having the same/similar refractive properties with respect to ordinary and extraordinary linear polarizations P1 and P2 (birefringence of the same sign).
3. Metamaterial.
5. Transmitted filtered beam/electromagnetic signal with P2 (corresponds to band-pass filter).

### Example 12.3

### FIG. 18 Filter:

1. Incident beam/coherent or incoherent electromagnetic signal.
2. & 4. Prisms made out of birefringent materials (such as, for example, calcite) having complementary refractive properties with respect to ordinary and extraordinary linear polarizations P1 and P2 (birefringence of opposite signs).
3. Metamaterial.
5. Transmitted filtered beam/electromagnetic signal with P2 (corresponds to band-pass filter).

### Example 12.4

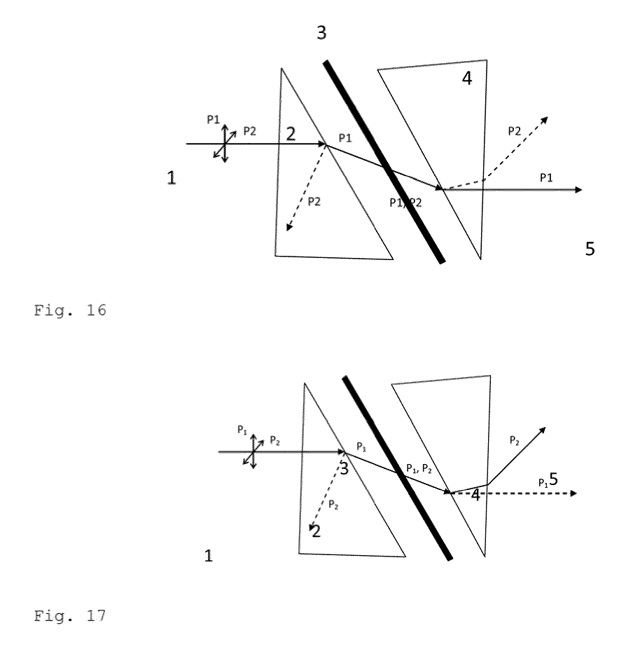

### FIG. 19 Filter:

1. Incident beam/coherent or incoherent electromagnetic signal.
2. & 4. Prisms made out of birefringent materials (such as, for example, calcite) having complementary refractive properties with respect to ordinary and extraordinary linear polarizations P1 and P2 (birefringence of opposite signs).
3. Metamaterial.
5. Transmitted filtered beam/electromagnetic signal with P1 (corresponds to notch filter).

### Example 13.1

### FIG. 20 Filter:

1. Incident beam/coherent or incoherent electromagnetic signal.
2. Prisms made out of birefringent materials (such as, for example, calcite). P1 and P2 are ordinary and extraordinary linear polarizations associated with the birefringence.
3. Metamaterial.
4. Transmitted filtered beam/electromagnetic signal with P1 (corresponds to notch filter).

### Example 13.2

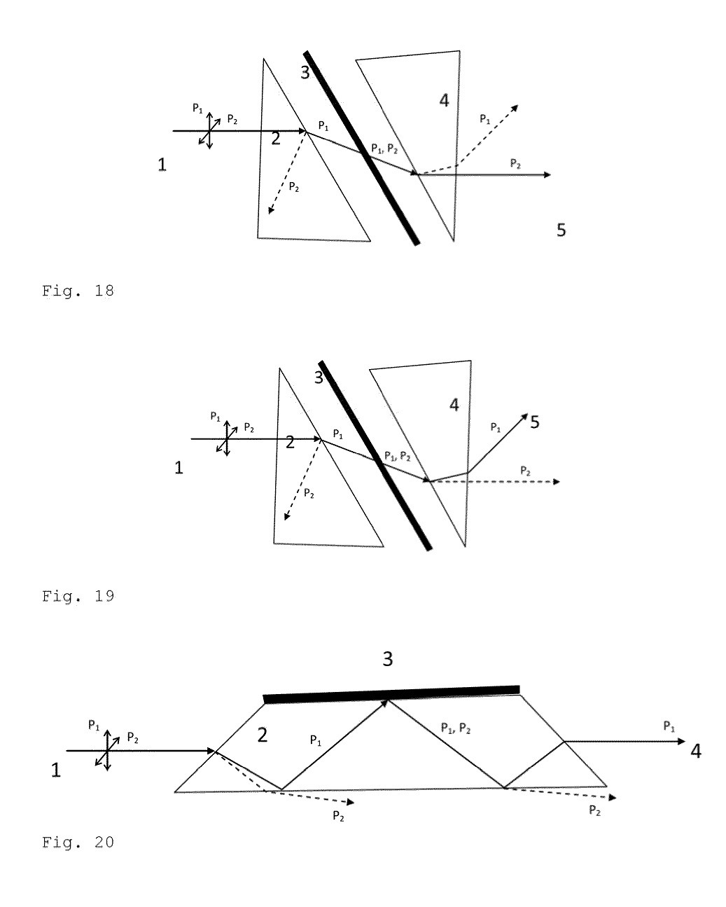

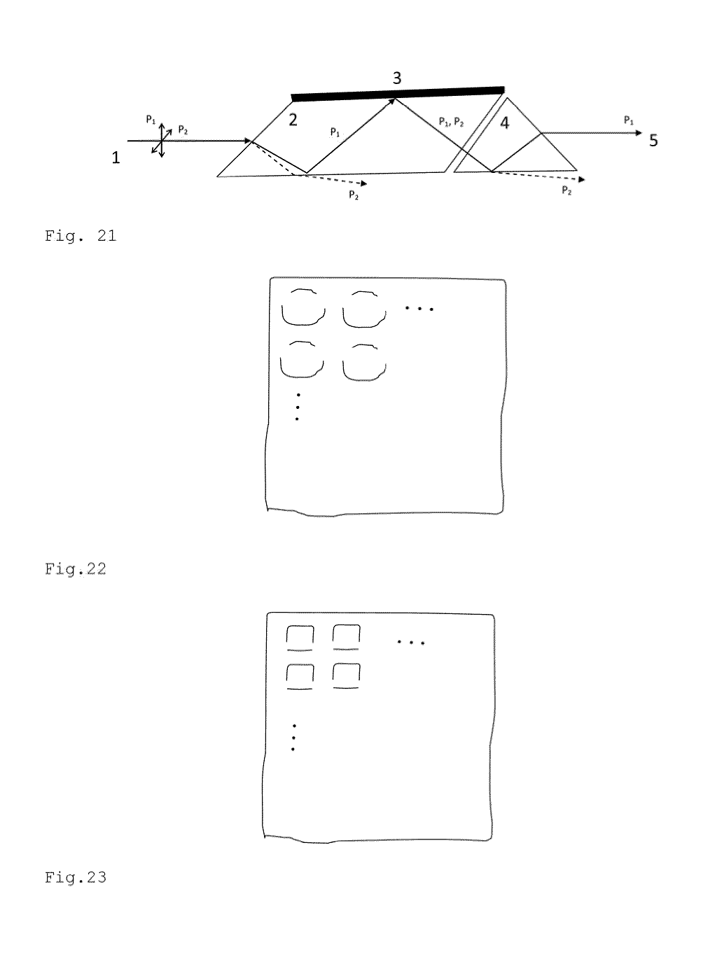

### FIG. 21 Filter:

1. Incident beam/coherent or incoherent electromagnetic signal.
2. & 4. Prisms made out of birefringent materials (such as, for example, calcite) having complementary refractive properties with respect to ordinary and extraordinary linear polarizations P1 and P2 (birefringence of opposite signs).
3. Metamaterial.
5. Transmitted filtered beam/electromagnetic signal with P1 (corresponds to notch filter).

### Example 1

FIG. 22 Metamaterial for use in filter:
Realizations could for example be based on any of the following materials:
   1) Metal (e.g. gold, silver, aluminium, chromium, . . . )
   2) Dielectric (e.g. glass, plastic, . . . )
   3) Semiconductor (e.g. silicon, gallium arsenide, germanium, . . . )
   4) Superconductor (e.g. niobium, . . . )
   5) Gain media (e.g. erbium doped glass, quantum dots, . . . )
   6) Non-linear material
   7) Switchable media
   8) Phase-change material (e.g. GLS, . . . )
   9) Stretchable/elastic material
In particular, realizations could consist of:
   1) Slits in any of the above media
   2) Wires made from one material, supported by substrate(s) made from another material on one or both sides.

### Example 2

FIG. 23 Metamaterial for use in filter:
Realizations could for example be based on any of the following materials:
   1) Metal (e.g. gold, silver, aluminium, chromium, . . . )
   2) Dielectric (e.g. glass, plastic, . . . )
   3) Semiconductor (e.g. silicon, gallium arsenide, germanium, . . . )
   4) Superconductor (e.g. niobium, . . . )
   5) Gain media (e.g. erbium doped glass, quantum dots, . . . )
   6) Non-linear material
   7) Switchable media
   8) Phase-change material (e.g. GLS, . . . )
   9) Stretchable/elastic material
In particular, realizations could consist of:
   1) Slits in any of the above media
   2) Wires made from one material, supported by substrate(s) made from another material on one or both sides.

### Example 3

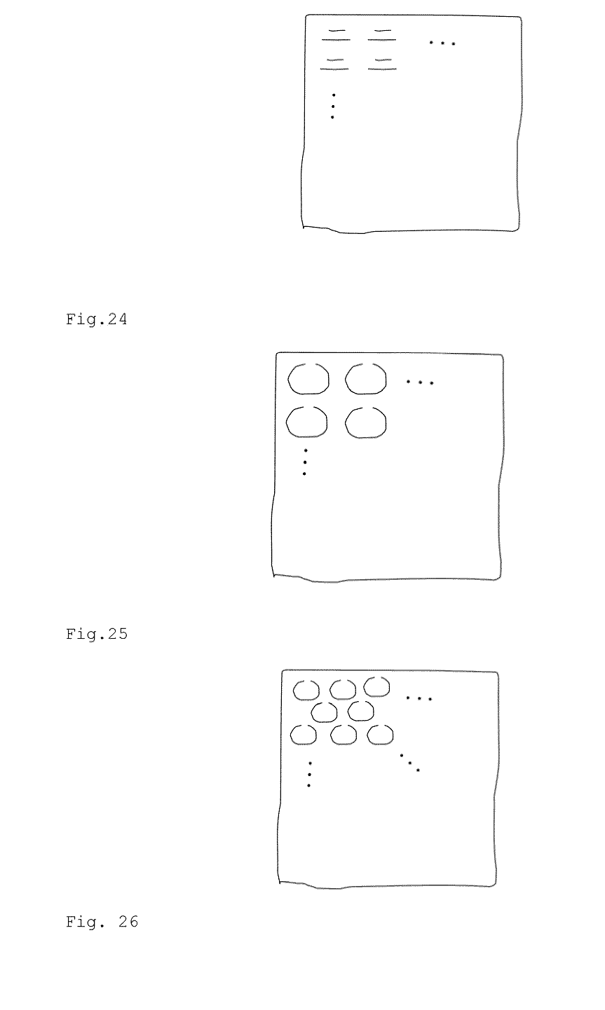

FIG. 24 Metamaterial for use in filter:
Realizations could for example be based on any of the following materials:
   1) Metal (e.g. gold, silver, aluminium, chromium, . . . )
   2) Dielectric (e.g. glass, plastic, . . . )
   3) Semiconductor (e.g. silicon, gallium arsenide, germanium, . . . )
   4) Superconductor (e.g. niobium, . . . )
   5) Gain media (e.g. erbium doped glass, quantum dots, . . . )
   6) Non-linear material
   7) Switchable media
   8) Phase-change material (e.g. GLS, . . . )
   9) Stretchable/elastic material
In particular, realizations could consist of:
   1) Slits in any of the above media
   2) Wires made from one material, supported by substrate(s) made from another material on one or both sides.

### Example 4

FIG. 25 Metamaterial for use in filter:
Realizations could for example be based on any of the following materials:
   1) Metal (e.g. gold, silver, aluminium, chromium, . . . )
   2) Dielectric (e.g. glass, plastic, . . . )
   3) Semiconductor (e.g. silicon, gallium arsenide, germanium, . . . )
   4) Superconductor (e.g. niobium, . . . )
   5) Gain media (e.g. erbium doped glass, quantum dots, . . . )
   6) Non-linear material
   7) Switchable media
   8) Phase-change material (e.g. GLS, . . . )
   9) Stretchable/elastic material
In particular, realizations could consist of:
   1) Slits in any of the above media
   2) Wires made from one material, supported by substrate(s) made from another material on one or both sides.

### Example 5

FIG. 26 Metamaterial for use in filter:
Realizations could for example be based on
   1) Square arrays
   2) Rectangular arrays
   3) Hexagonal arrays (shown above)
Realizations could for example be based on any of the following materials:
   1) Metal (e.g. gold, silver, aluminium, chromium, . . . )
   2) Dielectric (e.g. glass, plastic, . . . )
   3) Semiconductor (e.g. silicon, gallium arsenide, germanium, . . . )
   4) Superconductor (e.g. niobium, . . . )
   5) Gain media (e.g. erbium doped glass, quantum dots, . . . )
   6) Non-linear material
   7) Switchable media
   8) Phase-change material (e.g. GLS, . . . )
   9) Stretchable/elastic material
In particular, realizations could consist of:
   1) Slits in any of the above media
   2) Wires made from one material, supported by substrate(s) made from another material on one or both sides.

### Example 6

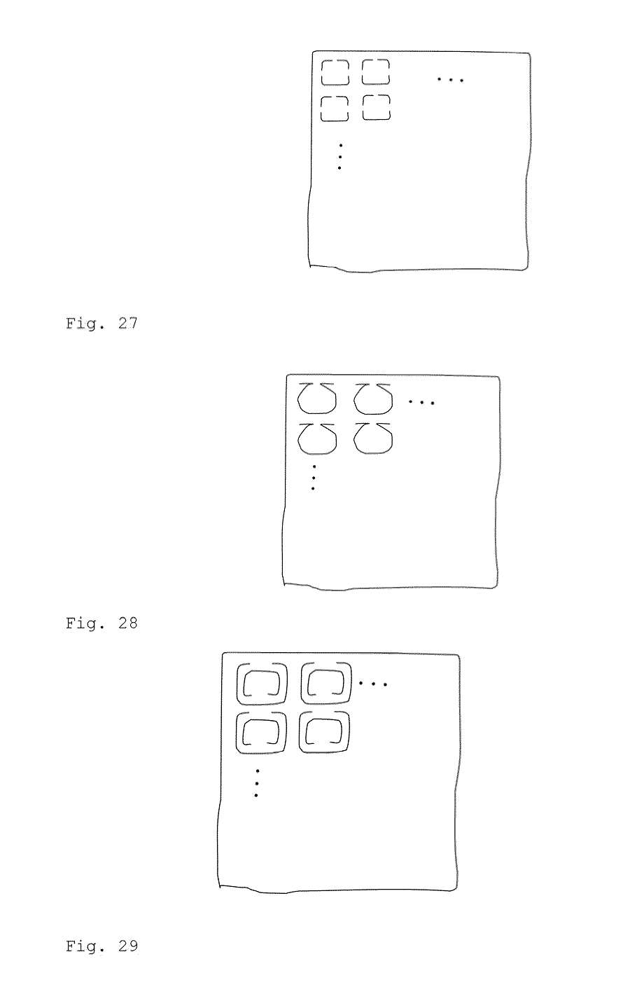

FIG. 27 Metamaterial for use in filter:
Realizations could be based on wires or apertures with one, two, three or more splits.
Realizations could for example be based on any of the following materials:
   1) Metal (e.g. gold, silver, aluminium, chromium, . . . )
   2) Dielectric (e.g. glass, plastic, . . . )
   3) Semiconductor (e.g. silicon, gallium arsenide, germanium, . . . )
   4) Superconductor (e.g. niobium, . . . )
   5) Gain media (e.g. erbium doped glass, quantum dots, . . . )
   6) Non-linear material
   7) Switchable media
   8) Phase-change material (e.g. GLS, . . . )
   9) Stretchable/elastic material
In particular, realizations could consist of:
   1) Slits in any of the above media
   2) Wires made from one material, supported by substrate(s) made from another material on one or both sides.

### Example 7

FIG. 28 Metamaterial for use in filter:
Realizations could for example be based on any of the following materials:
   1) Metal (e.g. gold, silver, aluminium, chromium, . . . )
   2) Dielectric (e.g. glass, plastic, . . . )
   3) Semiconductor (e.g. silicon, gallium arsenide, germanium, . . . )
   4) Superconductor (e.g. niobium, . . . )
   5) Gain media (e.g. erbium doped glass, quantum dots, . . . )
   6) Non-linear material
   7) Switchable media
   8) Phase-change material (e.g. GLS, . . . )
   9) Stretchable/elastic material
In particular, realizations could consist of:
   1) Slits in any of the above media
   2) Wires made from one material, supported by substrate(s) made from another material on one or both sides.

### Example 8

FIG. 29 Metamaterial for use in filter:

Realizations could for example be based on any of the following materials:
1) Metal (e.g. gold, silver, aluminium, chromium, . . . )
2) Dielectric (e.g. glass, plastic, . . . )
3) Semiconductor (e.g. silicon, gallium arsenide, germanium, . . . )
4) Superconductor (e.g. niobium, . . . )
5) Gain media (e.g. erbium doped glass, quantum dots, . . . )
6) Non-linear material
7) Switchable media
8) Phase-change material (e.g. GLS, . . . )
9) Stretchable/elastic material
In particular, realizations could consist of:
   1) Slits in any of the above media
   2) Wires made from one material, supported by substrate(s) made from another material on one or both sides.

### Example 9

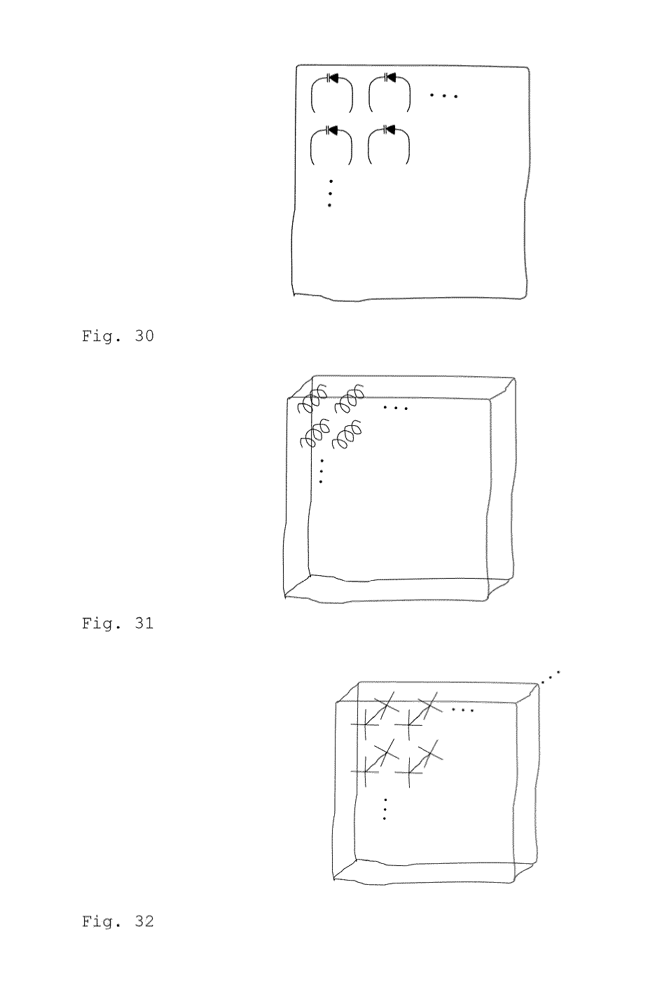

FIG. 30 Metamaterial for use in filter:
Varactors or other non-linear circuit elements can be part of the metamaterial pattern.
In the example shown above additional wires (not shown) may be used to allow for a controllable voltage over the varactors.
Realizations could for example be based on any of the following materials:
   1) Metal (e.g. gold, silver, aluminium, chromium, . . . )
   2) Dielectric (e.g. glass, plastic, . . . )
   3) Semiconductor (e.g. silicon, gallium arsenide, germanium, . . . )
   4) Superconductor (e.g. niobium, . . . )
   5) Gain media (e.g. erbium doped glass, quantum dots, . . . )
   6) Non-linear material
   7) Switchable media
   8) Phase-change material (e.g. GLS, . . . )
   9) Stretchable/elastic material
In particular, realizations could consist of wires made from a conducting material, supported by substrate(s) made from another material on one or both sides.

### Example 10

FIG. 31 Metamaterial for use in filter:
The filter can be based on a 3D-chiral metamaterial, like this helical structure.
Realizations could for example be based on any of the following materials:
   1) Metal (e.g. gold, silver, aluminium, chromium, . . . )
   2) Dielectric (e.g. glass, plastic, . . . )
   3) Semiconductor (e.g. silicon, gallium arsenide, germanium, . . . )
   4) Superconductor (e.g. niobium, . . . )
   5) Gain media (e.g. erbium doped glass, quantum dots, . . . )
   6) Non-linear material
   7) Switchable media
   8) Phase-change material (e.g. GLS, . . . )
   9) Stretchable/elastic material
In particular, realizations could consist of:
   1) Slits in any of the above media
   2) Wires made from one material, supported by substrate(s) made from another material on one or both sides.

### Example 11

FIG. 32 Metamaterial for use in filter:
The filter can be based on a 3D-chiral metamaterial, like this structure consisting of several layers of mutually twisted patterns in parallel planes.
Realizations could for example be based on any of the following materials:
   1) Metal (e.g. gold, silver, aluminium, chromium, . . . )
   2) Dielectric (e.g. glass, plastic, . . . )
   3) Semiconductor (e.g. silicon, gallium arsenide, germanium, . . . )
   4) Superconductor (e.g. niobium, . . . )
   5) Gain media (e.g. erbium doped glass, quantum dots, . . . )
   6) Non-linear material
   7) Switchable media
   8) Phase-change material (e.g. GLS, . . . )
   9) Stretchable/elastic material
In particular, realizations could consist of:
   1) Slits in any of the above media
   2) Wires made from one material, supported by substrate(s) made from another material on one or both sides.

### Example 12

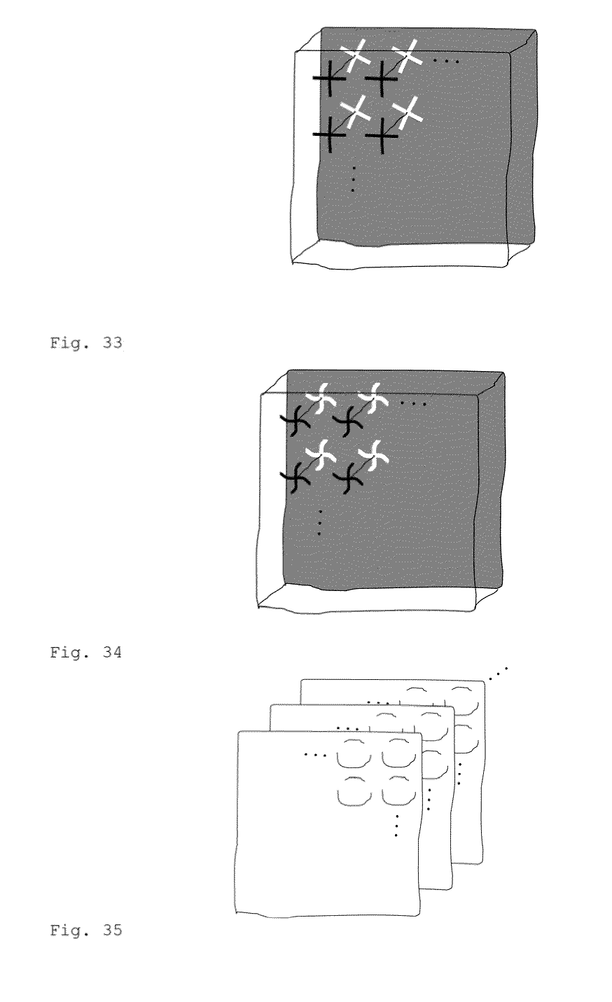

FIG. 33 Metamaterial for use in filter:
The filter can be based on a 3D-chiral metamaterial, like this structure consisting of mutually twisted wire-patterns and aperture-patterns in parallel planes.
Realizations could for example be based on any of the following materials:
   1) Metal (e.g. gold, silver, aluminium, chromium, . . . )
   2) Dielectric (e.g. glass, plastic, . . . )
   3) Semiconductor (e.g. silicon, gallium arsenide, germanium, . . . )
   4) Superconductor (e.g. niobium, . . . )
   5) Gain media (e.g. erbium doped glass, quantum dots, . . . )
   6) Non-linear material
   7) Switchable media
   8) Phase-change material (e.g. GLS, . . . )
   9) Stretchable/elastic material
In particular, such a structure could be made from wires of one material, supported by a substrate made from another material that holds a patterned layer of a third material.

### Example 13

FIG. 34 Metamaterial for use in filter:
The filter can be based on a 3D-chiral metamaterial, like this structure consisting of wire-patterns and aperture-patterns in parallel planes.
Realizations could for example be based on any of the following materials:
   1) Metal (e.g. gold, silver, aluminium, chromium, . . . )
   2) Dielectric (e.g. glass, plastic, . . . )
   3) Semiconductor (e.g. silicon, gallium arsenide, germanium, . . . )
   4) Superconductor (e.g. niobium, . . . )
   5) Gain media (e.g. erbium doped glass, quantum dots, . . . )
   6) Non-linear material
   7) Switchable media
   8) Phase-change material (e.g. GLS, . . . )
   9) Stretchable/elastic material
In particular, such a structure could be made from wires of one material, supported by a substrate made from another material that holds a patterned layer of a third material.

### Example 14

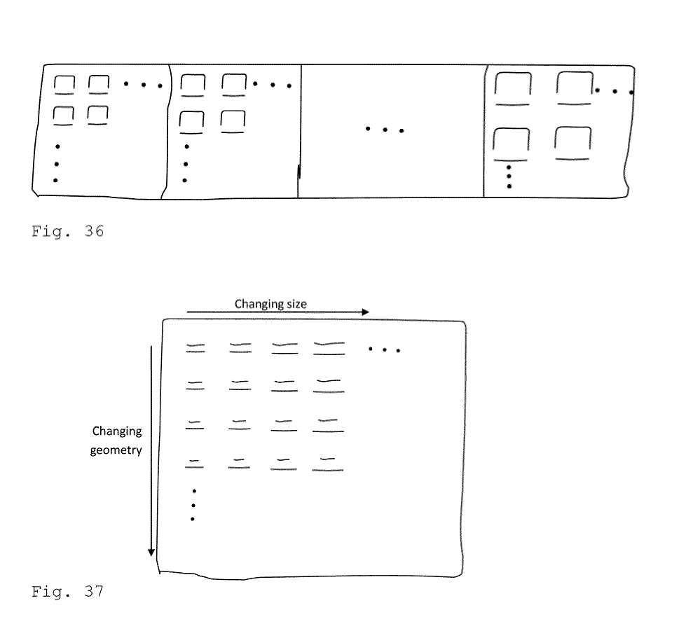

FIG. 35 Metamaterial for use in filter:
The filter can be based on multi-layered forms of any of the metamaterial structures shown in any example.
Realizations could for example be based on any of the following materials:
   1) Metal (e.g. gold, silver, aluminium, chromium, . . . )
   2) Dielectric (e.g. glass, plastic, . . . )
   3) Semiconductor (e.g. silicon, gallium arsenide, germanium, . . . )
   4) Superconductor (e.g. niobium, . . . )
   5) Gain media (e.g. erbium doped glass, quantum dots, . . . )
   6) Non-linear material
   7) Switchable media
   8) Phase-change material (e.g. GLS, . . . )
   9) Stretchable/elastic material
In particular, realizations could consist of:
   1) Slits in any of the above media
   2) Wires made from one material, supported by substrate(s) made from another material on one or both sides.

### Example 15

FIG. 36 Metamaterial for use in filter:
The above example shows a metamaterial where the unit cell size is changed in discrete steps.
The filter can be based on a metamaterial that changes properties in discrete steps or continuously.
Properties that could be changed in this way include:
   1) The unit cell size
   2) The unit cell geometry
   3) Doping levels of a semiconductor components or gain media
   4) The properties of non-linear components such as varactor diodes
   5) The twist of chiral components
Realizations could for example be based on any of the following materials:
   1) Metal (e.g. gold, silver, aluminium, chromium, . . . )
   2) Dielectric (e.g. glass, plastic, . . . )
   3) Semiconductor (e.g. silicon, gallium arsenide, germanium, . . . )
   4) Superconductor (e.g. niobium, . . . )
   5) Gain media (e.g. erbium doped glass, quantum dots, . . . )
   6) Non-linear material
   7) Switchable media
   8) Phase-change material (e.g. GLS, . . . )
   9) Stretchable/elastic material
In particular, realizations could consist of:
   1) Slits in any of the above media
   2) Wires made from one material, supported by substrate(s) made from another material on one or both sides.

### Example 16

FIG. 37 Metamaterial for use in filter:
The above example shows a metamaterial where the unit cell size and geometry are changed continuously.
The filter can be based on a metamaterial that changes properties in discrete steps or continuously.
Properties that could be changed in this way include:
   1) The unit cell size
   2) The unit cell geometry
   3) Doping levels of a semiconductor components or gain media
   4) The properties of non-linear components such as varactor diodes
   5) The twist of chiral components
Realizations could for example be based on any of the following materials:
   1) Metal (e.g. gold, silver, aluminium, chromium, . . . )
   2) Dielectric (e.g. glass, plastic, . . . )
   3) Semiconductor (e.g. silicon, gallium arsenide, germanium, . . . )
   4) Superconductor (e.g. niobium, . . . )
   5) Gain media (e.g. erbium doped glass, quantum dots, . . . )
   6) Non-linear material
   7) Switchable media
   8) Phase-change material (e.g. GLS, . . . )
   9) Stretchable/elastic material
In particular, realizations could consist of:
   1) Slits in any of the above media
   2) Wires made from one material, supported by substrate(s) made from another material on one or both sides.

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. An optical filter, comprising:
an initial polarizer receiving the electromagnetic radiation;
a final polarizer spaced from said initial polarizer along the beam path;
a metamaterial element positioned between them; and
only selected parts of the incoming electromagnetic radiation are outputted from the final polarizer.

2. The optical filter of claim 1, wherein the initial and the final polarizer are linear polarizers, and the final polarizer is of the same or perpendicular orientations.

3. The optical filter of claim 1, wherein the initial polarizer and the final polarizer are circular polarizers, and the final polarizer set to transmit light of the same or opposite circular polarizations.

4. The optical filter of claim 1, wherein said metamaterial element exhibits linear birefringence.

5. The optical filter of claim 1, wherein said metamaterial element exhibits linear dichroism.

6. The optical filter of claim 1, wherein said metamaterial element exhibits circular birefringence.

7. The optical filter of claim 1, wherein said metamaterial element exhibits circular dichroism.

8. The optical filter of claim 1, wherein said metamaterial element has linear birefringence which is equal to zero at a given wavelengths.

9. The optical filter of claim 1, wherein said metamaterial element has circular dichroism which is equal to zero at a given wavelengths.

10. The optical filter of claim 1, wherein said metamaterial element has linear dichroism which is equal to zero at given wavelengths.

11. The optical filter of claim 1, wherein said metamaterial element has circular dichroism which is equal to zero at a given wavelengths.

12. The optical filter of claim 1, wherein said metamaterial element contains at least one of metals, dielectrics, semiconductor materials, superconductor materials, phase change materials, gain materials, non-linear materials and/or electronic components.

13. The optical filter of claim 1, wherein said metamaterial element is a metal screen with a regular pattern of identical slit designs each of which has no centre of symmetry.

14. The optical filter of claim 1, wherein said metamaterial element is a transparent substrate supporting a regular pattern of identical metal designs each of which has no centre of symmetry.

15. The optical filter of claim 1, wherein said metamaterial element is a metal screen with a regular pattern of asymmetrically split ring slits.

16. The optical filter of claim 1, wherein said metamaterial element is a transparent substrate supporting a regular pattern of asymmetrically split wire rings.

17. The optical filter of claim 1, wherein said metamaterial element is a regular pattern of identical metal designs each of which is chiral.

18. The optical filter of claim 1, wherein said metamaterial element is a combination of various types of metamaterials.

19. The optical filter of claim 1, wherein the electromagnetic radiation is microwave electromagnetic radiation.

20. The optical filter of claim 1, wherein the electromagnetic radiation is terahertz electromagnetic radiation.

21. The optical filter of claim 1, wherein the electromagnetic radiation is infrared electromagnetic radiation.

22. The optical filter of claim 1, wherein the initial and the final polarizer are metamaterial elements.

23. The optical filter of claim 1, wherein the initial and the final polarizer are wire grid media.
